(19) United States
(12) Patent Application Publication
(10) Pub. No.: US 2012/0037090 A1
(43) Pub. Date: Feb. 16, 2012

(54) AUTOMATIC HEADGATE

(75) Inventor: Brian K. Manwaring, Orem, UT (US)

(73) Assignee: POWDER RIVER, INC., Provo, UT (US)

(21) Appl. No.: 12/854,443

(22) Filed: Aug. 11, 2010

(51) Int. Cl. A01K 15/04; A01K 29/00

(52) U.S. Cl. 119/730; 119/740; 119/843

(57) ABSTRACT

A headgate including pair of upright frame members with a pair of weight members disposed therein which are connected to a pair of stanchions operable to move from an open position to a closed position by pivoting linkages. A release mechanism simultaneously releases the weight members from a first position such that gravity causes the weight members to move from the first position to a second position located at a lower height than the first position upon receiving a signal from a tripping mechanism which automatically detects the presence of an animal, wherein the release of the weight members causes the pair of stanchions to move from an open position, which allows an animal to pass therethrough, to a closed position, which causes the stanchions to close so as to confine the animal.

### BACKGROUND OF THE INVENTION

1. The Field of the Invention

The present invention relates to a livestock headgate for use in a squeeze chute, calving pen, maternity pen, and the like. More specifically, the present invention relates to a livestock headgate which is capable of being self-triggered or remotely triggered.

2. The Relevant Technology

Headgates are commonly used to assist in the restraint of livestock. Headgates are often used in association with squeeze chutes or other type of pen where an animal may be contained for various purposes such as inspection, branding, tagging, doctoring, weighing, or the like. Typically, headgates include a pair yokes which slide from a fully-open position, which allows the animal passage through the headgate, and a closed position, which engages with an animal's neck so as to prevent the animal from passing through the headgate. More specifically, by locking around an animal's neck in order to hold the animal in place, the headgate enables a veterinarian or other animal worker to safely access the animal, while the animal is held in place.

One problem with conventional headgates, however, is that they are often unwieldy and difficult to use. For example, many headgates require multiple operators, generally with one operator positioned at the front of the headgate where the tripping mechanism which causes the headgate to open and close is located. One disadvantage of having an operator at the front of the headgate, however, is that the operator is typically visible to the animal, which may cause the animal to stress or hesitate before attempting to pass through the front of the headgate.

Another disadvantage conventional headgates is that they are generally manually tripped, meaning that a human operator must manually trigger the mechanism that causes the headgate to close around the animal's neck. One problem with these configurations is that it is often difficult to accurately trip the mechanism so that the headgate closes at the correct time. For example, if the headgate is tripped too early, the headgate may close before the animal's head has passed through the headgate, and the animal would not be properly confined. Alternatively, if the headgate is tripped too late, the headgate may close around the animal's midsection, resulting in harm to the animal or allowing the animal to escape.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE INVENTION

A first aspect of the invention is a headgate including a pair of generally upright frame members with a hollow interior portion and a surface with a plurality of through slots formed therein, a pair of weight members disposed within the hollow interior portion of each of the upright frame members, a pair of stanchions operable to move from an open position to a closed position, a plurality of pivoting linkages connecting each of the weight members to one stanchion of the pair of stanchions via the plurality of through slots formed in the upright member, a release mechanism which simultaneously releases the weight members from a first position such that gravity causes the weight members to move from the first position to a second position located at a lower height than the first position, and a tripping mechanism which automatically detects the presence of an animal and causes the release mechanism to release the weight members. When the weight members are at a first position the pivoting linkages cause pair of stanchions to be in the open position where an opening is formed between the pair of stanchions which is sized and shaped so that the animal may pass there through, and wherein when the weight members are released the pivoting linkages cause the pair of stanchions to move from the open position to the closed position where the opening formed in the headgate between the pair of stanchions is sized and shaped so as to confine the animal about its neck.

A second aspect of the invention is a headgate including a frame assembly including a top cross piece, a bottom cross pieces, and a pair of generally upright frame members extending from the bottom cross piece to the top cross piece, the upright frame members having a hollow interior portion and a surface with a plurality of through slots formed therein, a pair of weight members disposed within the hollow interior portion of each of the upright frame members, a pair of stanchions operable to move from an open position to a closed position, a pair of roller guides, each disposed at the top of one of the pair of stanchions and which enable the pair of stanchions to be guided as the roller guides roll along the top cross piece, a plurality of pivoting linkages connecting each of the weight members to one stanchion of the pair of stanchions via the plurality of through slots formed in the upright member, a release mechanism which simultaneously releases the weight members from a first position such that gravity causes the weight members to move from the first position to a second position located at a lower height than the first position, and a tripping mechanism which automatically detects the presence of an animal and causes the release mechanism to release the weight members. When the weight members are at a first position the pivoting linkages cause pair of stanchions to be in the open position where an opening is formed between the pair of stanchions which is sized and shaped so that the animal may pass there through, and wherein when the weight members are released the pivoting linkages cause the pair of stanchions to move from the open position to the closed position where the opening formed in the headgate between the pair of stanchions is sized and shaped so as to confine the animal about its neck.

A third aspect of the invention is a headgate including a pair of generally upright frame members with a hollow interior portion and a surface with a plurality of through slots formed therein, a pair of weight members disposed within the hollow interior portion of each of the upright frame members, a pair of stanchions operable to move from an open position to a closed position, a plurality of pivoting linkages connecting each of the weight members to one stanchion of the pair of stanchions via the plurality of through slots formed in the upright member, a holding means which holds the weight members at a first position, a release mechanism which simultaneously releases the weight members from the first position held by the holding means such that gravity causes the weight members to move from the first position to a second position located at a lower height than the first position, and a tripping mechanism which automatically detects the presence of an animal and causes the release mechanism to release the weight members. When the weight members are at a first position the pivoting linkages cause pair of stanchions to be in the open position where an opening is formed between the pair of stanchions which is sized and shaped so that the animal may pass there through, and wherein when the weight members are released the pivoting linkages cause the pair of stanchions to move from the open position to the closed position where the opening formed in the headgate between the pair of stanchions is sized and shaped so as to confine the animal about its neck.

As described more fully below, one advantage of the described aspects of the invention is that the headgate is capable of automatically closing around the neck of an animal, without requiring a human operator to trigger the closing mechanism. This provides advantages over the current art by reducing the stress to the animal and improving the safety of operating the headgate.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 shows an illustrative example of a front view of an automatic headgate;

FIG. 2A shows an illustrative example of a front view of the automatic headgate in an open position;

FIG. 2B shows an illustrative example a front view of the automatic headgate in a closed position;

FIG. 3 shows an illustrative example of a isometric view of a frame which may incorporate the headgate in one embodiment of the invention;

FIGS. 4 to 5 are illustrative examples of closer views of the ratchet of the headgate;

FIG. 6 shows an illustrative example of a top view of a ratchet and solenoid unit of the automatic headgate;

FIG. 7 shows an illustrative example of a front view of the headgate illustrating a tripping mechanism of the invention according to one embodiment;

FIGS. 8A-8C shows an illustrative example of a top view of the headgate illustrating a tripping mechanism of the invention according to another embodiment;

FIG. 9 shows an illustrative example of another isometric view of the headgate according to another embodiment of the invention;

FIG. 10 shows an illustrative example of an embodiment of the invention integrated with a livestock chute;

FIG. 11 shows an illustrative example of a flow chart illustrating a method of the invention; and

FIG. 12 shows an illustrative example of a flow chart illustrating an embodiment of the invention which is integrated with a livestock chute.

### DETAILED DESCRIPTION OF THE PREFERRED EMBODIMENTS

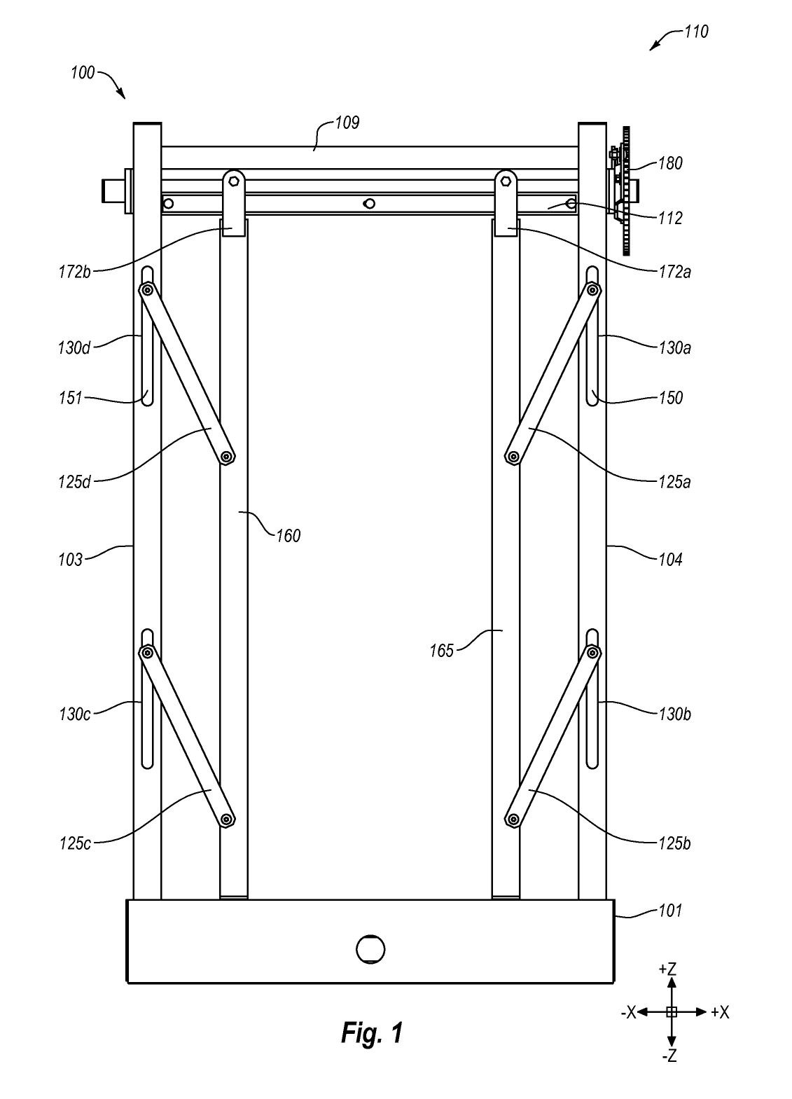

Embodiments of the invention relate to an animal headgate restraining device, which as shown in FIGS. 1-12, comprises a headgate 100, including frame assembly 110 which provides a support and basic structure for the components of the headgate 100. In order to simplify the description of the headgate 100, FIG. 1 illustrates the basic components of the frame assembly 110, with several additional parts removed so as to simplify the description of the functional elements of the invention. The frame assembly 110 includes a base 101 which forms a platform for supporting a number of uprights, including a left-hand (LH) front upright 104 and a right-hand (RH) front upright 103. As described herein, the designations of right-hand and left-hand are determined from the perspective of an animal restrained in the headgate 100.

As is illustrated in FIG. 1, the base 101 forms the bottom support for the LH front upright 104 and the RH front upright 103. The LH front upright 104 and RH front upright 103 extend from the base 101 in the +z direction. The LH front upright 104 and the RH front upright 103 are connected by a guide member 112 and a top front cross piece 109. Both the LH front upright 104 and the RH front upright 103 are hollow members with an opening formed therein where weighting members 150 and 151 are disposed. The LH front upright 104 and the RH front upright 103 also have two slots 130a-130d formed therein which allow the weighting members 150 and 151 to be exposed and connected to a pair of stanchions 160 and 165 via a series of pivoting linkages 125a-125d.

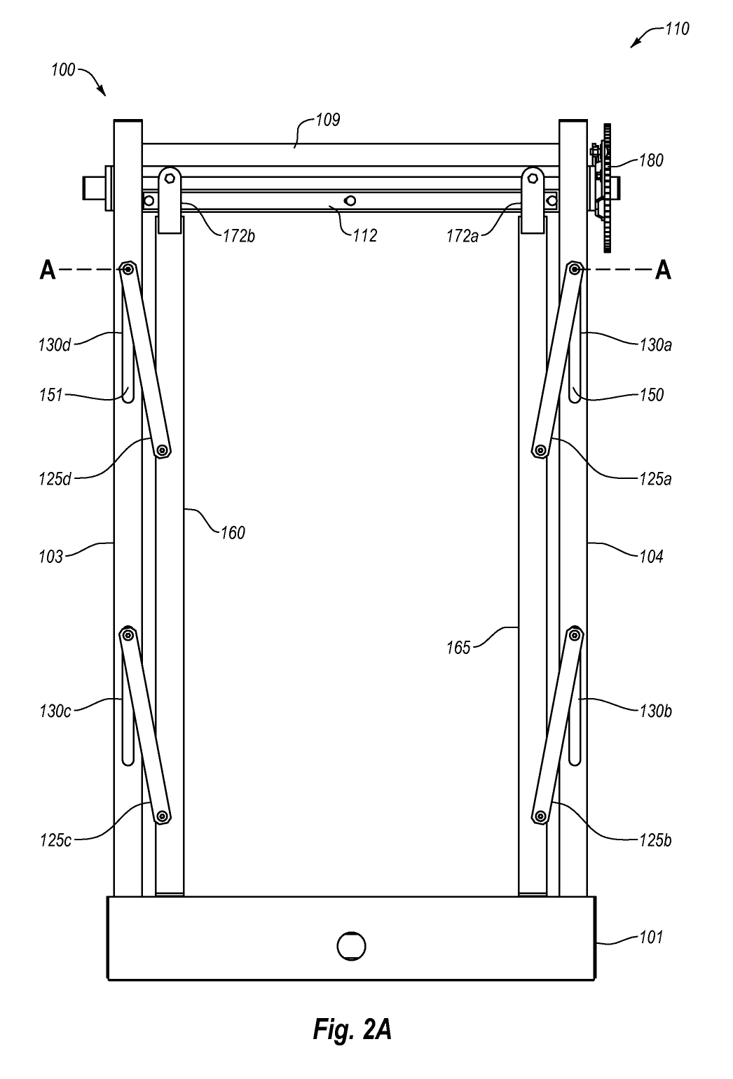

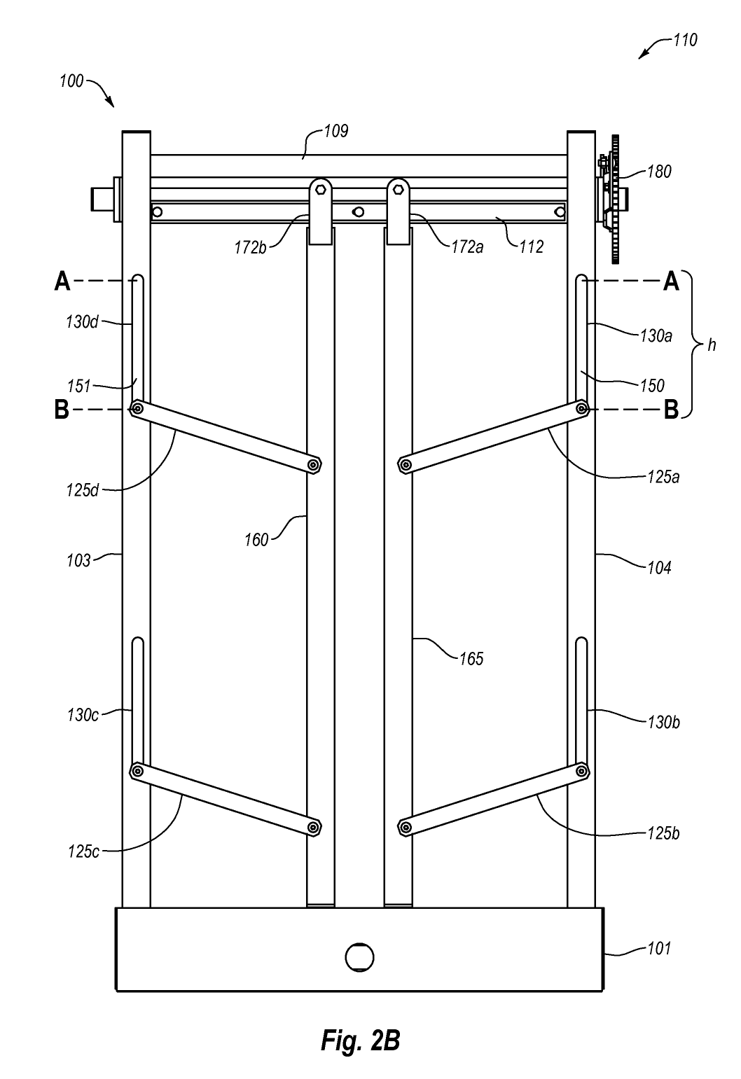

As illustrated in FIGS. 2A and 2B, the headgate open and closes as the weighting members 150 and 151 are moved between an elevated position and a released position. More specifically, when the headgate 100 is in the open position, as shown in FIG. 2A, the weighting members 150 and 151 are held at an elevated position A, illustrated by the height of the connection between the pivoting linkages 125a and 125d to the weighting members 150 and 151, respectively.

When the release mechanism 180 is triggered by a tripping mechanism, as described more fully below, the release mechanism 180 causes the weighting members 150 and 151 to be released from the elevated position A within the LH front upright 104 and the RH front upright 103. As shown in FIG. 2B, the weighting members 150 and 151 are released from the elevated position, gravity causes the weighting members 150 and 151 to fall a distance h to a released position B within the LH front upright and 104 and RH front upright 103, although the change in position may also be assisted by automatic and/or manual power. When the weighting members 150 and 151 move from the elevated position A to the released position B, the pivoting linkages 125a-125d pivot, causing the stanchion 160 to move away from the RH front upright 103 and the stanchion 165 to move away from the LH front upright 104. Thus the stanchions 160 and 165 are moved to a closed position as a pair of guide brackets 172a-172b connected to the stanchions 160 and 165 slide along the guide member 112 by means of a pair of rollers (not shown) disposed within the brackets 172a-172b which rotate along a surface of the guide member 112.

In one embodiment, when the weighting members 150 and 151 are released from the elevated position and fall the distance h to the released position B shown in FIG. 2B, the weighting members 150 and 151 are stopped and supported when a portion of the weighting members 150 and 151 reaches the base 101. More specifically, the base 101 supports the weight of the weighting members 150 and 151 when the weighting members 150 and 141 are in the released position B shown in FIG. 2B.

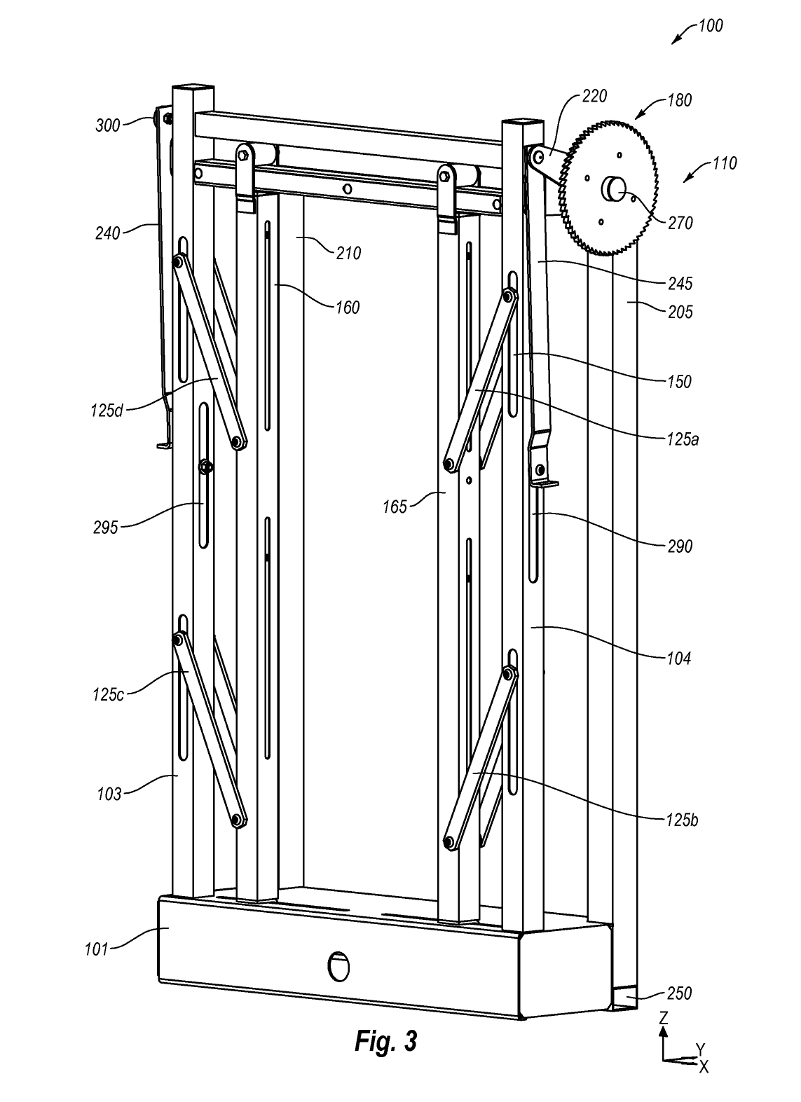

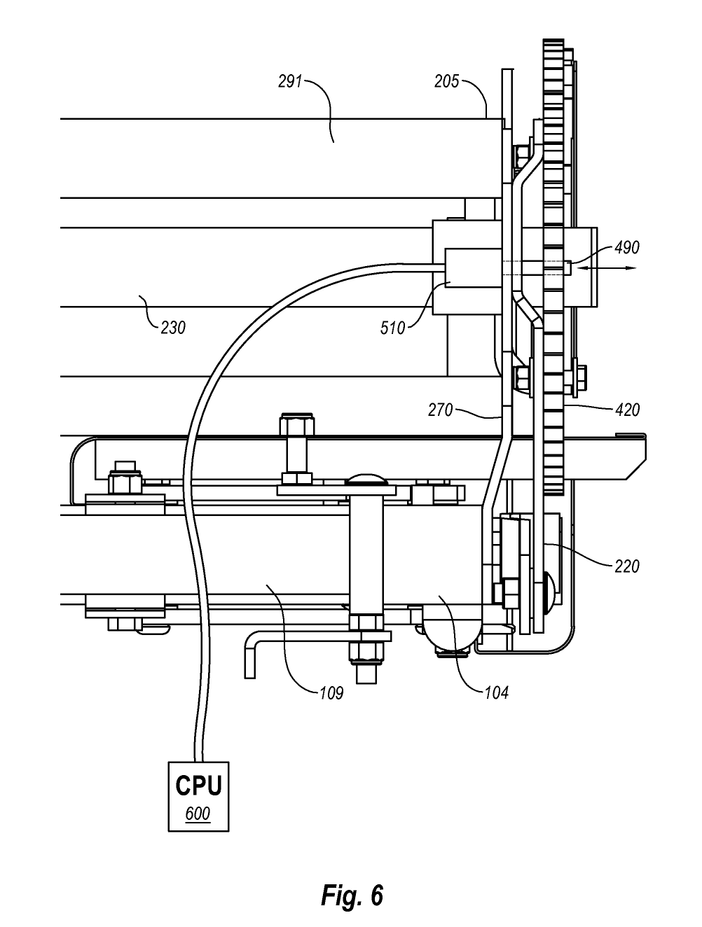

As shown in FIG. 3, in some embodiments, the frame 110 of the headgate 100 may include additional structural components, including a LH back upright 205 and RH back upright 210 which both extend in the z direction from the base 101 and an additional base tube 250 which runs along the length of the base 101 in the x-direction. The LH back upright 205 is connected to the LH front upright 104 by a LH top connection plate 270, while the RH front upright 103 is connected to the RH back upright 210 via a RH top connection plate 280, which is shown in FIG. 6. The LH back upright 205 is connected to the RH back upright by a rear top cross piece 291, as shown in FIG. 6. One advantage of the additional components of the frame 110 is that the headgate 100 may have increased structural support and durability.

In the embodiments described herein, the LH front upright 104, RH front upright 103, base 101, LH back upright 205, RH back upright 210, LH top connection plate 270, RH top connection plate 280, rear top cross piece 291, top front cross piece 102 and guide member 112, are examples of non-moving elements of the frame 110 are made, by way of example only, of steel tubing, steel pipe or other suitable structural materials. The attachments between these components is made using any appropriate conventional means such as welding, bolting or pinning.

Furthermore, various other components of the system, including the ratchet 420, the weighting members 150 and 151, the stanchions 160 and 165, the sliding bar 245 and 240, and rotating top bar 230 (described more fully below) may also be made of steel tubing, steel plate, steel bar, steel pipe, or other suitable structural materials.

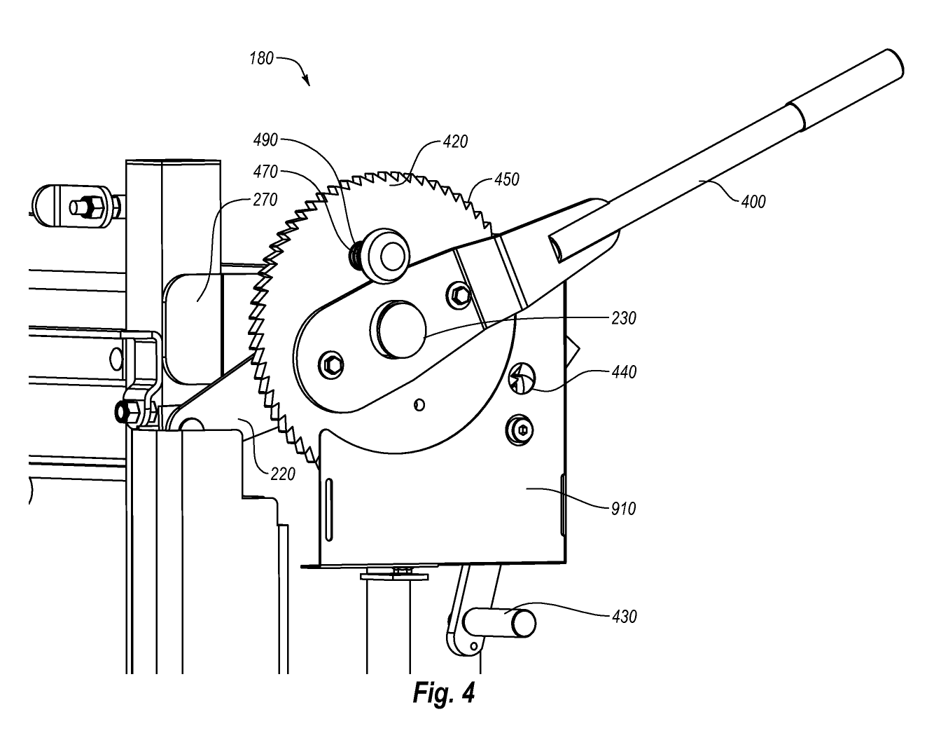

In the embodiment illustrated in FIGS. 3 and 4, the release mechanism 180 includes a ratchet 420 and a handle 400. The release mechanism 180 is linked to the weighting member 150 via a rotating arm 220 which is connected to a sliding plate 245 disposed on an outer edge of the LH front upright 104. The sliding plate 245 connects to the weighting member 150 via a release connection slot 290 formed in the LH front upright 104. As shown in FIG. 3, in this embodiment, the release connection slot 290 is formed on a different surface of the LH front upright 104 than the slots 130a and 130b.

As described more fully below, when the release mechanism 180 is triggered, the ratchet 420 is released from a holding state, where the rotating arm 220 holds the sliding plate 245 in the position A shown in FIG. 2A, and the rotating arm 220 rotates along with the ratchet 420, causing the sliding plate 245 to slide along the LH front upright 104, such that the weighting member connected to the sliding plate 245 moves from the position A shown in FIG. 2A to the position B shown in FIG. 2B. As described above, by releasing the weighting member 150, the pivoting linkages 125a and 125b pivot, causing the stanchion 165 to move to the closed position.

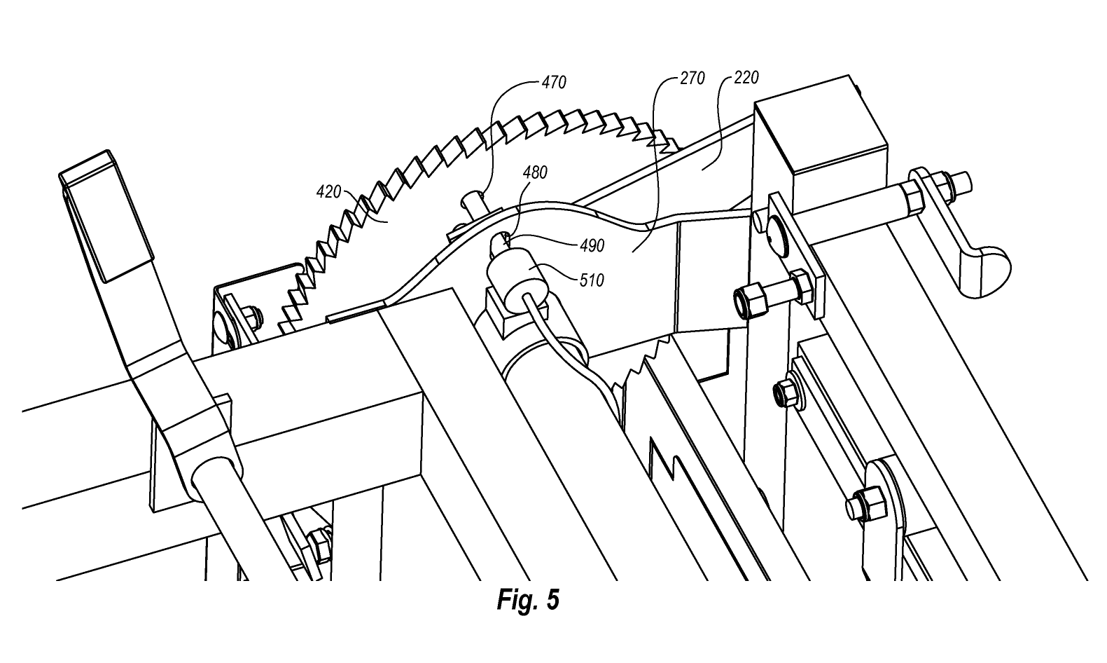

Returning to FIGS. 3 and 6, the release mechanism 180 has a rotating top bar 230 which is attached to the ratchet 420 and the handle 400. The rotating top bar 230 extends through a hole (not shown) in the LH top connection plate 270 across the top of the headgate 100 and through a hole in the RH top connection plate 280. As shown in FIG. 5, the rotating top bar 230 is connected on the left-hand side of the headgate 100 to a sliding plate 240 (shown in FIG. 3) via a RH rotating arm 300. Thus, when the ratchet 420 is released from the holding position and is allowed to rotate, the rotating top bar 230 also rotates, simultaneously causing the rotating arm 220 and the RH rotating arm 300 to pivot.

As previously described, when the ratchet 420 is released from the holding position, the rotating top bar 230 and rotating arm 220 rotate, while the sliding plate 245 slides, due to the force of gravity acting on the weighting member 150, causing the stanchion 165 moves to a closed position. Similarly, the weight and stored kinetic energy of the weighting member 151 in the RH front upright 103, which is connected to the RH rotating arm 300 via sliding plate 240 through a release connection slot 295 formed in the RH front upright 10, also urges the rotation of the rotating top bar 230, and consequently the ratchet 420.

As such, when the rotating top bar 230 is permitted to rotate with the release of the ratchet 420, the RH rotating arm 300 connected to the rotating top bar 230 is able to pivot from the position A shown in FIG. 2A to the position B shown in FIG. 2B, as the sliding plate 240 slides along the slots 130c and 130d. In one embodiment, the RH rotating arm 300 has the same structure and performs a similar function as the rotating arm 220, but is connected to the right-hand portion of the headgate 100, whereas the rotating arm 220 is connected to the left-hand portion of the headgate 100. Thus, the weighting member 151 drops, the pivoting linkages 125c and 125d pivot and the stanchion 160 is also moved the closed position. Thus, using the embodiment illustrated in FIG. 3, the release mechanism 180 causes both stanchions 160 and 165 to close at the same time.

FIG. 4 is a close up illustration of the release mechanism 180 of one embodiment. As previously described, the release mechanism 180 includes a ratchet 420 and a handle 400 which are linked to the stanchions 160 and 165. In this embodiment, the ratchet 420 is held by a release pin 490 shown in FIGS. 5 and 6, which is capable of extending through a hole 480 formed through the LH top connection plate 270 and a corresponding hole 470 in the ratchet 420 in order to hold the ratchet 420 in place. The release pin 490 is also capable of retracting so that the release pin 490 is removed from the hole 470 in the ratchet 420, releasing the ratchet 420 and allowing the rotating top bar 230 to rotate in accordance with the urging force placed on the rotating top bar 230 by the weighting members 150 and 151 as described above.

In this embodiment, the extension and retraction of the release pin 490 is controlled by a solenoid unit 510, which causes the release pin 490 to move in response to an electrical current is turned on. In addition to this embodiment, any number of devices may be used which are capable of converting an electrical signal received from the tripping mechanism described below into motion of the ratchet 420, or more specifically, the weighting members 150 and 151.

As is described more fully below, the solenoid unit 510 may be connected to various computer programs which are capable of controlling the timing of the extension and refraction of the release pin 490. For example, in one embodiment, when the release pin 490 is moved so as to release the ratchet 420 from the open position shown in FIG. 2A, the solenoid unit 510 may cause the release pin 490 to stay in a retracted position for a predetermined interval in order to ensure that the release pin 490 does not immediately reengage with the hole 470 formed in the ratchet 420.

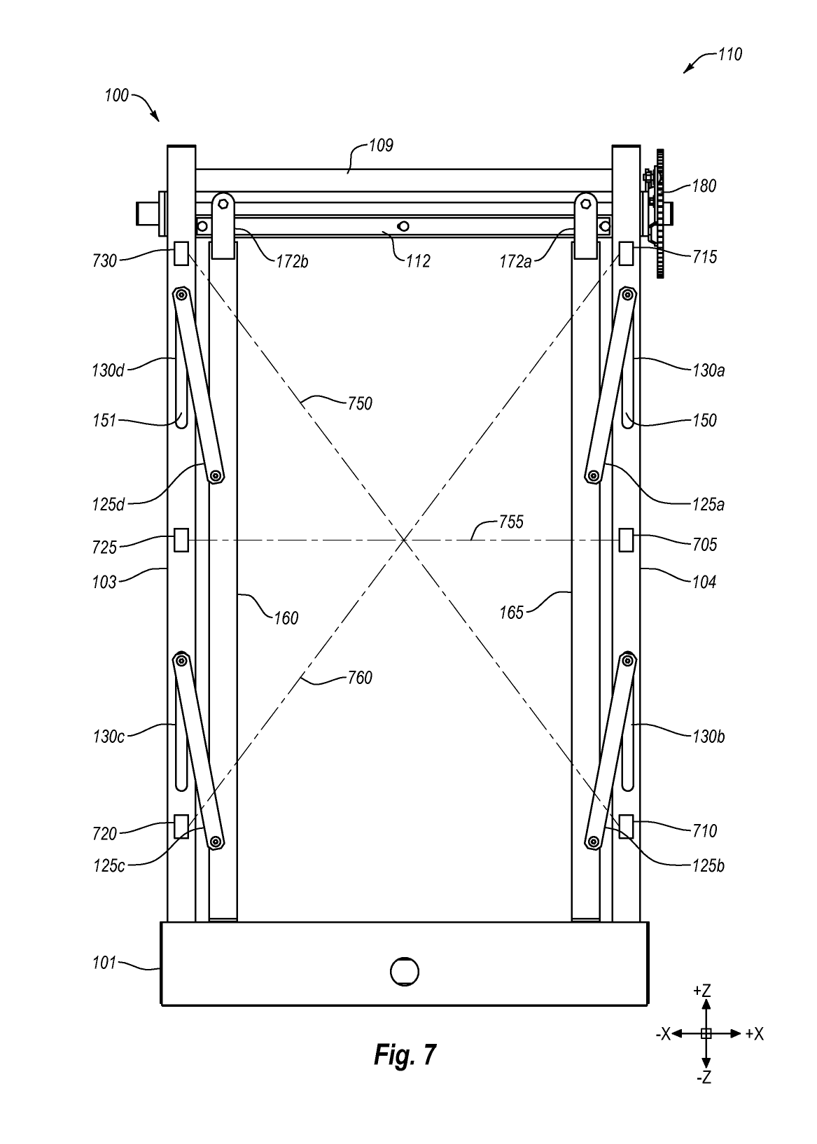

FIG. 7 illustrates one embodiment of a tripping mechanism which may be used in association with embodiments of the invention. In this embodiment, several light emitting/receiving elements 705, 710, 715, 720, 725, and 730 are positioned on the front of the frame 110. In this embodiment, the light emitting/receiving elements 705 and 725 are disposed opposite to each other in order to create a beam of light 755 which extends horizontally across the front of the headgate 100. The light emitting/receiving element 730 is disposed opposite to the light emitting/receiving element 710 so as to create a beam of light 750 that extends in the diagonal direction across the front of the headgate 100. And the light emitting/receiving element 715 is disposed opposite to the light emitting/receiving element 720 so as to create another beam of light 760 which also extends in the diagonal direction across the front of the headgate 100.

The light emitting/receiving elements 705, 710, 715, 720, 725, and 730 are connected electronically to the solenoid unit 510, such that when one or more of the beams of light 750, 755, or 760, is broken by an animal coming into the path of the beam of light 750, 755, and 760, an electronic signal is sent to the solenoid unit 510, causing the release pin 490 to be retracted and releasing the ratchet 420 due to the urging of the weighting members 150 and 151. As previously described, when the ratchet 420 is released by the pin 490 being retracted from the hole 470 in the ratchet 420, the weighting members 150 and 151 drop the distance h shown in FIG. 2B and the headgate closes around the neck of the animal.

In one embodiment, the solenoid and tripping mechanism may be connected to a computer or processing unit (CPU) 600, as shown in FIG. 6. In such embodiments, the CPU 600 may use logic or a program so as to control or delay the activation of the solenoid unit 510 once the tripping mechanism is tripped. For example, in the embodiment described above, the light emitting/receiving elements 705, 710, 715, 720, 725, and 730, which comprise one example of a tripping mechanism which may be used in association with the invention, may send an electronic signal to the CPU 600 indicating that the mechanism has been tripped. Then, the CPU 600 may use an electronic timer to delay the activation of the solenoid unit 510, such that the ratchet 420 and weighting members 150 and 151 are not released for a predetermined period of time after the tripping mechanism is tripped. Such a delay may be advantageous in order to ensure that the headgate 100 is not closed before the neck portion of the animal is through the headgate 100.

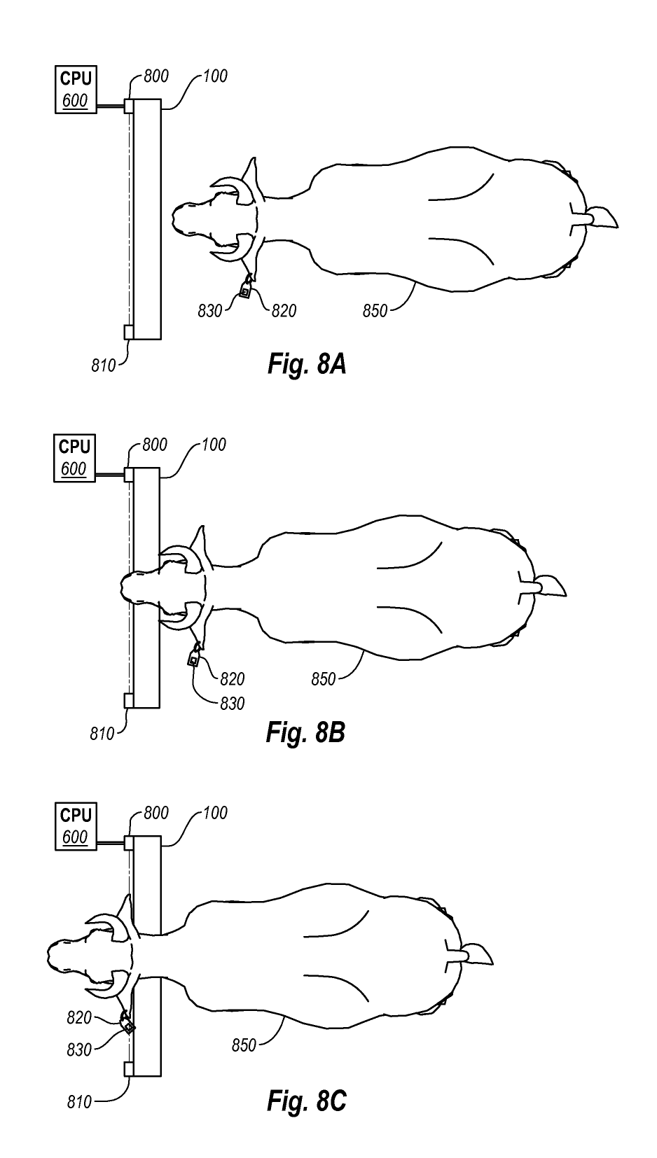

FIGS. 8A-8C illustrate the tripping mechanism of another embodiment of the invention. In this configuration, which contains only the tripping mechanism as viewed from the top so as to clarify this portion of the invention, the tripping mechanism includes one or more radio frequency identification or “RFID” detectors 800 and 810 which would be disposed on the headgate 100 so as to detect an animal 850. In this embodiment, the animal 850 has been previously tagged with an ear tag 820 or other tag, such as those often used in the art, which contains an RFID 830 which transmits a signal which may be detected by the RFID detectors 800 or 810.

As shown in FIG. 8A, the animal approaches the headgate 100, the headgate 100 is in open position, such that the animal 850 is able to pass through the headgate 100. When the headgate is in open position, the animal 850 is naturally herded toward the open space at the front of the headgate 100, as shown in FIG. 8B. At the point where the RFID 830 on the ear tag 820 is detected by the detector 810, however, a signal is sent to the solenoid unit 510 by the detector 810 and the headgate 100 is caused to close around the animal's neck.

In this embodiment, in addition to adding the delay logic described above, the CPU 600 may also detect and receive an identifier or other information from the RFID 830 on the ear tag 820, which may then be used to receive information corresponding to the specific animal. Typically, such information would include a name or number identifying the specific animal 850, the animal's age, weight, and in some instances, the animal's health. Advantageously, the detection of the RFID 830 may be used not only to trigger the closing of the headgate 100 so that the animal 650 may be safely and efficiently worked, but also may be used to automatically retrieve information via the CPU 600 related to the animal 650 which would be useful in monitoring and maintaining the animal.

Although two RFID detectors 800 and 810 are used in the configuration described above, the specific number of RFID detectors may be varied. Similarly, in the embodiment illustrated in FIG. 7, any number of light emitting units may be used. Furthermore, a variety of different configurations may be used as a tripping mechanism, including, but not limited to a photoelectric sensor which is capable of detecting the presence of the animal using a light transmitter, such as an infrared sensor and a detector. Alternatively, a tripping wire may be placed in a position so as to mechanically move when the animal passes through the headgate. In another embodiment, an inductance or conductance loop may be used, which is capable of detecting the change in an electro or magnetic field due to the presence of an animal. Further, a motion sensor may also be used or a scale or weight detector.

Additionally, any combination of these or other known detection mechanisms may be used. For example, the photoelectric sensor, light curtain, inductance/conductance loop, tripping wire, motion sensor described above or others known in the art may be used in association with a livestock scale, such that the CPU 600 does not cause the headgate 100 to close when a tripping signal is received from the photoelectric sensor or light curtain unless an object of at least a predetermined weight is determined to be on a scale disposed behind the headgate 100. As such, as described below, the specific type and configuration of the tripping mechanism may be modified so as to be used in association with another piece of livestock equipment, such as a chute, a calving or other pen, or a livestock scale.

Further, in another embodiment, the photoelectric sensor, light curtain, inductance/conductance loop, tripping wire, motion sensor described above or others known in the art may be used in association with the RFID 830 of the animal's ear tag 820, such that the CPU 600 does not cause the headgate 100 to close unless an RFID detector 800 or 810 also detects an RFID 830 in the headgate 100. Thus, various different programs and types of computer logic may be implemented by the CPU 600 in order to ensure that the mechanism triggers properly.

Finally, although the sensors and detectors of the embodiments described herein are located on the front of the headgate 100, the sensors and detectors may be located any number of locations on, within, or near the headgate 100 without departing from the scope of the claims. For example, in one embodiment, a sensor may be disposed on the opposite surface, or back surface, of the headgate 100 from the configuration illustrated in FIGS. 8A-8C. In such an embodiment, the sensor may be coupled with delay logic such that a predetermined period of time between the triggering of the sensor and the tripping of the release mechanism of the headgate 100. Thus, the specific location of the sensors may be varied depending on the specific configuration of the headgate 100.

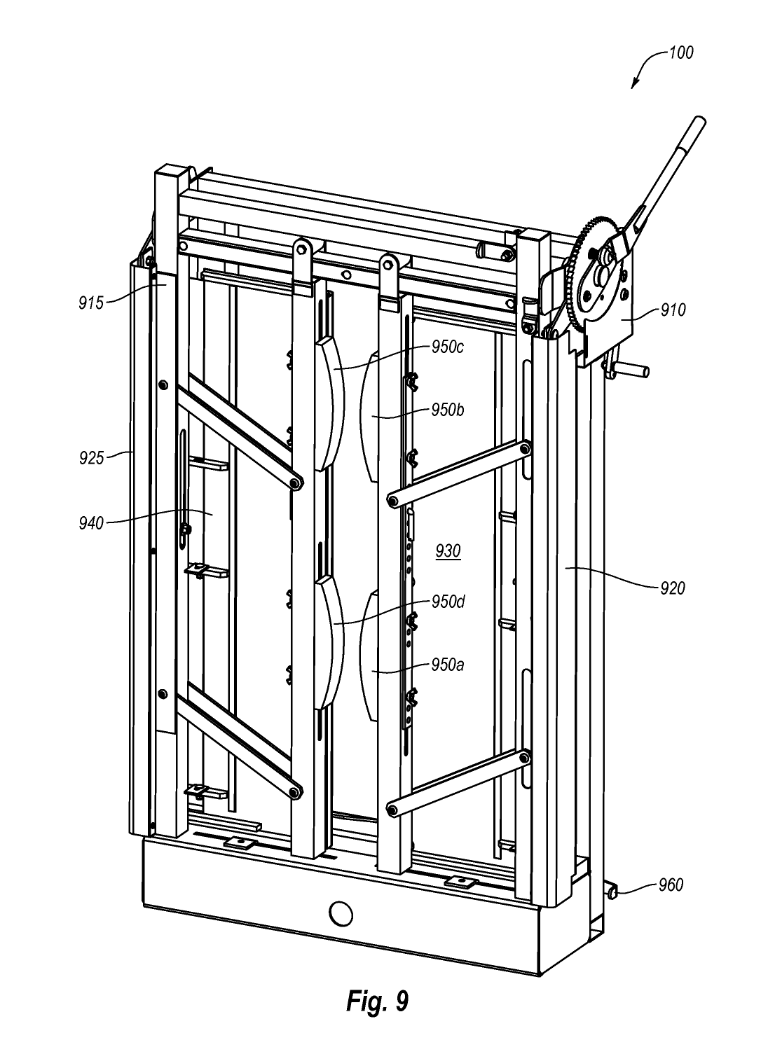

As shown in FIG. 9, the headgate 100 may include additional components without departing from the meaning or scope of the invention. For example, front corner covers 920 and 925 may be disposed around the RH front upright 103 and LH front upright and 104 so as to protect and cover the slots 130a-130d which expose the weighting members 150 and 151. In addition, or in alternative to the front corner covers 920 and 925, a front plate 915 may be used.

A ratchet cover plate 910 is also included in the embodiment illustrated in FIG. 9, which ensures that nothing is caught by the ratchet 420 or otherwise interferes with the rotation of the ratchet 420.

FIG. 9 also illustrates the use of a RH cover 940 and a LH cover 930 and four yokes 950a-950d which act as a means for stopping the RH stanchion 160 and LH stanchion 165 when the stanchions are in closed position and also provide the ability to vary and modify the desired neck opening for confining the animal. The headgate 100 shown in FIG. 9 also includes a connecting means 960 by which the headgate 100 may be connected to other livestock equipment, including, but not limited to corrals, pens, fences, scales, chutes, and the like.

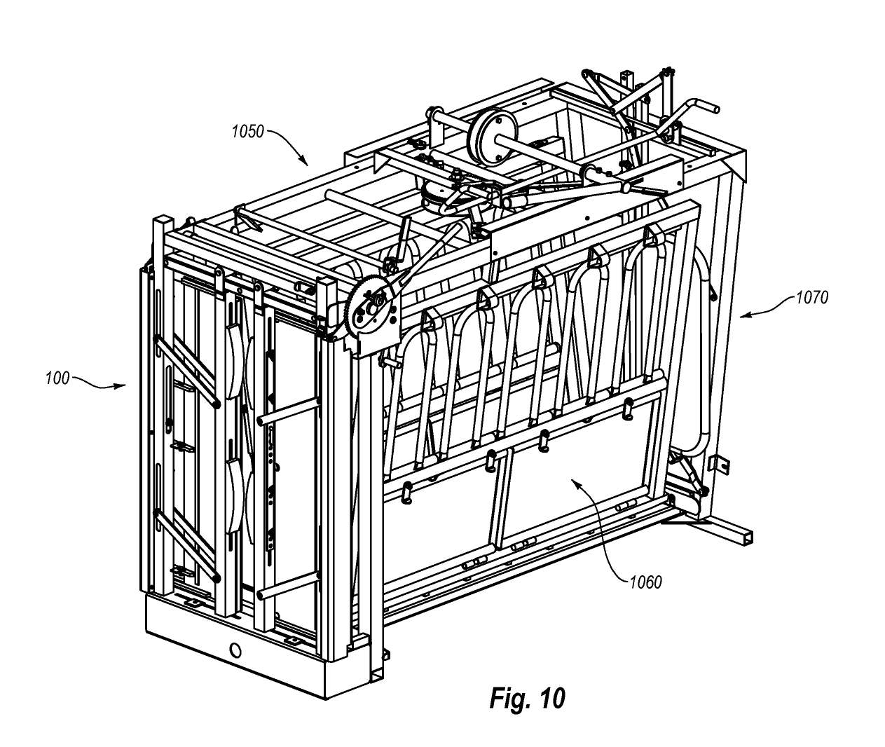

FIG. 10 illustrates an embodiment of the invention where the headgate 100 is integrated with a livestock chute 1050, which includes a squeezing portion 1060, wherein two panels move towards the animal after the animal is contained by the neck in the headgate 100, in addition to a tailgate portion 1070, which closes behind an animal after the animal enters the chute area 1050 in order to ensure that the animal continues through the headgate 100.

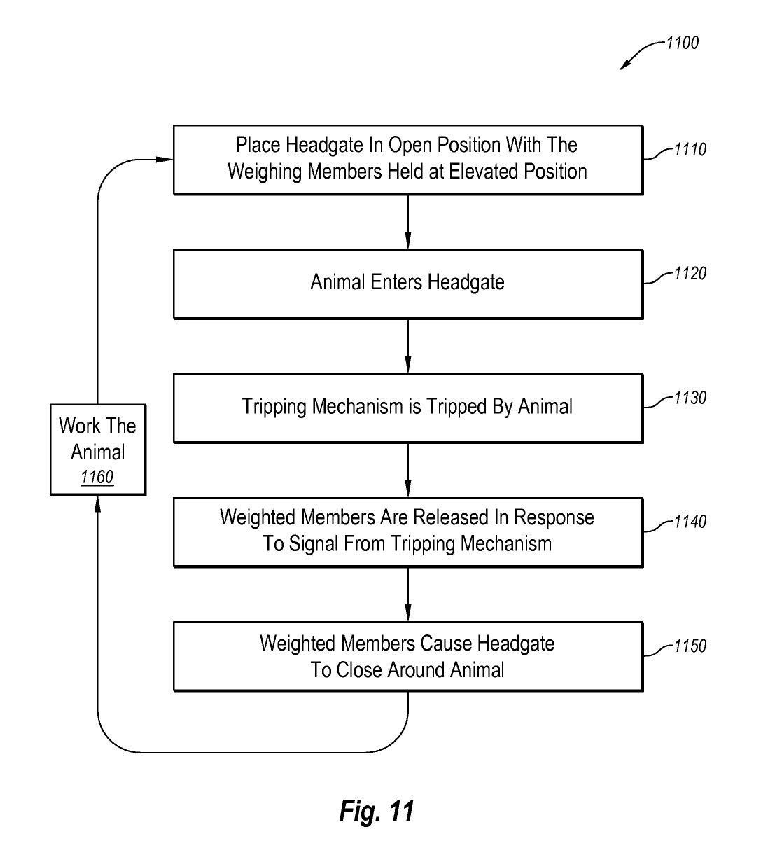

FIG. 11 is a flow chart 1100 illustrating a method of operating the headgate 100 of the invention. At 1110, the headgate 100 is placed in open position, as shown in FIG. 2A. In one embodiment of the invention, the headgate 100 may be placed in open position from a closed or semi-closed position using the handle 400 shown in FIG. 4. Using the handle 400, the ratchet 420 may be rotated in the clockwise direction, causing the LH top connection plate 270 to pivot and lift the weighting member 150 to be lifted to the elevated position via the sliding plate 245. At the same time, the rotating top bar 230 is rotated in the clockwise direction, causing the RH top connection plate 280 to pivot and lift the weighting member 151 to the elevated position via the sliding plate 240. After the weighting members 150 and 151 are returned to the elevated position, the solenoid unit 510 is reset and causes the weighting members 150 and 151 to be held in position via the ratchet 420.

In another embodiment, a motor or other means may be used to return the headgate 100 to the open position, although there is generally less danger in using a human operator to open the headgate from a closed position since the headgate is generally either empty and being opened for the first time in preparation for working animals, or the animal is already confined by the headgate 100. Thus, one aspect of the invention is the ability to automate the closing of the headgate 100, during the time when the stress to the animal is the greatest.

After the headgate 100 has been placed in open position at 1110 and the operator has ensured that the tripping mechanism is reset and working properly via the CPU 600, the operator may then move from the front or operational area of the headgate 100 where his or her presence would otherwise disturb the animal 850. Then the animal 850 is corralled or herded into the headgate 100 at 1120 using any number of herding means currently known in the art. Once the animal enters the headgate at 1120, the tripping mechanism is tripped by the animal 1130. Then, the weighted members 150 and 151 are released in response to a signal being sent from the tripping mechanism at 1140. As described above, the release of the weighted members 150 and 151 from the elevated position shown in FIG. 2A causes the headgate 100 to closes around the animal 850 at 1150.

When the headgate 100 closes around the animal, the weight of the weighted members 150 and 151 urging the headgate 100 in the closed position in addition to a engaging pawl 440 on a release handle 430 (shown in FIG. 4) may be used so as to lock the headgate in the closed position in order to ensure that the animal 850 cannot free itself from the headgate 100. Because the ratchet 420 has angled teeth 450, the ratchet 420 can rotate freely in the counter-clockwise position without fully engaging with the engaging pawl 440 of the release handle 430. Alternatively, when the ratchet 420 is urged so as to rotate in the clockwise direction, the engaging pawl 440 fully engages with the teeth 450 and the ratchet 420 is prevented from rotating.

Once thus confined, operators may then work on the animal 850 at 1160 in order to perform various maintenance and veterinarian procedures, such as treating the animal for disease, tagging the animal, or the like. Then, as described above, the headgate 100 may be manually opened by using the ratchet handle 400 as described above, while also operating the release handle 430, which releases the engaging pawl 440 and allows the ratchet 420 to rotate in the clockwise direction.

As previously described, a computer or processing unit may be used to delay the time between the tripping and the time when the weighted members 150 and 151 are released in the method described above in order to ensure that the animal is adequately through the headgate 100 when the headgate 100 is closed.

Further, the computer or processing unit, the tripping mechanism, and various other aspects of the invention may be powered by any number of power sources, including, but not limited by rechargeable power sources, battery power sources, generators, or solar power sources.

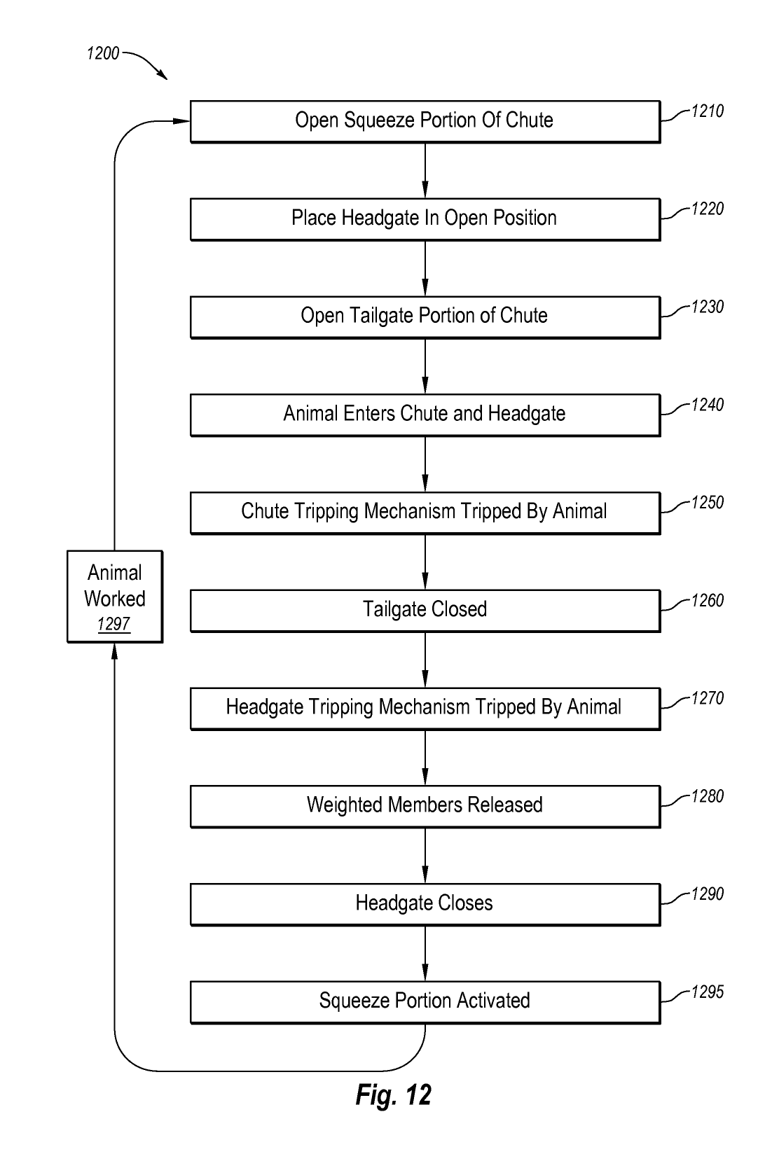

As described briefly below with reference to FIG. 12, in embodiments of the invention where the headgate 100 is integrated with the chute 1050 as shown in FIG. 10, additional logic and an additional tripping mechanism may be implemented so as to coordinate the various components of the integrated headgate 100 and chute 1050. As shown in FIG. 12, the process begins at 1210 with the squeeze portion 1060 of the chute 1050 being released or opened so that the squeeze portion 1060 is placed in a state where it would not interfere with the passage of an animal 850 through the chute 1050. Then, as described above with reference to FIG. 11, the headgate 100 is placed in an open position, as shown in FIG. 2A. At this time, the operator ensures that all the detection mechanisms are functioning properly.

Then the tailgate portion of the chute 1070 is opened at 1230, and the animal 850 is herded into the chute 1050 and headgate 100. In one embodiment, where an additional chute tripping mechanism is used, preferably toward the front of the squeeze portion 1060 but before the tripping mechanism of the headgate 100 described above, the chute tripping mechanism is tripped by the animal 850 at 1250. In response, the CPU 600 receives the tripping signal from the chute tripping mechanism and causes the tailgate 1070 portion of the chute 1050 to close at 1260, ensuring that the animal 850 remains enclosed in the chute 1050 and continues to proceed through the chute 1050 and headgate 100, rather than back through the tailgate portion 1070.

As the animal 850 proceeds through the chute 1050 and the headgate 100, the headgate tripping mechanism is tripped by the animal 850 at 1270. As described above, the CPU 600 receives the tripping signal from the headgate tripping mechanism, and causes the weighted members 150 and 151 to be released in the LH front upright 104 and RH front upright 103, and the headgate 100 closes around the animal's neck 1290. In an alternative configuration, the headgate 100 and tailgate portion 1070 may be simultaneously closed.

After the headgate 100 is caused to close at 1290, the CPU 600 uses additional logic and then causes the squeeze portion 1060 of the chute 1050 to be activated, and the squeeze portion 1060 squeezes the two panels together so as to enclose the animal 850.

Once the headgate 100 and tailgate 1070 are closed and the squeeze portion 1060 has properly enclosed and restrained the animal 850, the operator may then work the animal 850 at 1297. After the animal 850 has been worked, the operator sends a request to the CPU 600 which causes the system to return to 1210, and the squeeze portion 1060 of the chute 1050 is released and the headgate 100 is opened 1220, allowing the animal 850 to exit the chute 1050 and headgate 100.

In this embodiment, the CPU 600 may be programmed with logic, which ensures that the chute tripping mechanism and headgate tripping mechanism are not activated until the tailgate 1070 portion of the chute 1050 is opened and the system is reset in order to ensure that the chute 1050 and headgate 100 do not close on the animal 850 again as the animal 850 exits the chute 1050 and headgate 100. Alternatively, the chute tripping mechanism and headgate tripping mechanism may not be reset until the operator expressly sends a command to the CPU 600 resetting the system, such as using a button located near the tailgate portion 1070 of the chute 1050. As may be understood, any number of release or resetting mechanisms may be used.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other tangible medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A headgate comprising:
a pair of generally upright frame members with a hollow interior portion and a surface with a plurality of through slots formed therein;
a pair of weight members disposed within the hollow interior portion of each of the upright frame members;
a pair of stanchions operable to move from an open position to a closed position;
a plurality of pivoting linkages connecting each of the weight members to one stanchion of the pair of stanchions via the plurality of through slots formed in the upright member;
a release mechanism which simultaneously releases the weight members from a first position such that gravity causes the weight members to move from the first position to a second position located at a lower height than the first position; and
a tripping mechanism which automatically detects the presence of an animal and causes the release mechanism to release the weight members,
wherein when the weight members are at a first position the pivoting linkages cause pair of stanchions to be in the open position where an opening is formed between the pair of stanchions which is sized and shaped so that the animal may pass there through, and wherein when the weight members are released the pivoting linkages cause the pair of stanchions to move from the open position to the closed position where the opening formed in the headgate between the pair of stanchions is sized and shaped so as to confine the animal.

2. The headgate of claim 1, wherein the tripping mechanism comprises a light beam and a detector.

3. The headgate of claim 1, wherein the tripping mechanism comprises an electrical inductance detector.

4. The headgate of claim 1, wherein the tripping mechanism comprises an ultrasonic transmitter and detector.

5. The headgate of claim 1, wherein the release mechanism comprises a solenoid which causes an engaging pawl of a ratchet holding the weight members in a first position to release the weight members.

6. The headgate of claim 1, further comprising a connection means for connecting the headgate to a livestock chute.

7. The headgate of claim 1, further comprising a connection means for connecting the headgate to a livestock pen.

8. A headgate comprising:
a frame assembly including a top cross piece, a bottom cross pieces, and a pair of generally upright frame members extending from the bottom cross piece to the top cross piece, the upright frame members having a hollow interior portion and a surface with a plurality of through slots formed therein;
a pair of weight members disposed within the hollow interior portion of each of the upright frame members;
a pair of stanchions operable to move from an open position to a closed position;
a pair of roller guides, each disposed at the top of one of the pair of stanchions and which enable the pair of stanchions to be guided as the roller guides roll along the top cross piece;
a plurality of pivoting linkages connecting each of the weight members to one stanchion of the pair of stanchions via the plurality of through slots formed in the upright member;
a release mechanism which simultaneously releases the weight members from a first position such that gravity causes the weight members to move from the first position to a second position located at a lower height than the first position; and
a tripping mechanism which automatically detects the presence of an animal and causes the release mechanism to release the weight members,
wherein when the weight members are at a first position the pivoting linkages cause pair of stanchions to be in the open position where an opening is formed between the pair of stanchions which is sized and shaped so that the animal may pass there through, and wherein when the weight members are released the pivoting linkages cause the pair of stanchions to move from the open position to the closed position where the opening formed in the headgate between the pair of stanchions is sized and shaped so as to confine the animal.

9. The headgate of claim 8, wherein the tripping mechanism comprises a light beam and a detector.

10. The headgate of claim 8, wherein the tripping mechanism comprises an electrical inductance detector.

11. The headgate of claim 8, wherein the tripping mechanism comprises an ultrasonic transmitter and detector.

12. The headgate of claim 8, wherein the release mechanism comprises a solenoid which causes an engaging pawl of a ratchet holding the weight members in a first position to release the weight members.

13. The headgate of claim 8, further comprising a connection means for connecting the headgate to a livestock chute.

14. The headgate of claim 8, further comprising a connection means for connecting the headgate to a livestock pen.

15. A headgate comprising:
a pair of generally upright frame members with a hollow interior portion and a surface with a plurality of through slots formed therein;
a pair of weight members disposed within the hollow interior portion of each of the upright frame members;
a pair of stanchions operable to move from an open position to a closed position;
a plurality of pivoting linkages connecting each of the weight members to one stanchion of the pair of stanchions via the plurality of through slots formed in the upright member;
a holding means which holds the weight members at a first position;
a release mechanism which simultaneously releases the weight members from the first position held by the holding means such that gravity causes the weight members to move from the first position to a second position located at a lower height than the first position; and
a tripping mechanism which automatically detects the presence of an animal and causes the release mechanism to release the weight members,
wherein when the weight members are at a first position the pivoting linkages cause pair of stanchions to be in the open position where an opening is formed between the pair of stanchions which is sized and shaped so that the animal may pass there through, and wherein when the weight members are released the pivoting linkages cause the pair of stanchions to move from the open position to the closed position where the opening formed in the headgate between the pair of stanchions is sized and shaped so as to confine the animal.

16. The headgate of claim 1, wherein the tripping mechanism comprises a light beam and a detector.

17. The headgate of claim 1, wherein the tripping mechanism comprises an electrical inductance detector.

18. The headgate of claim 1, wherein the tripping mechanism comprises an ultrasonic transmitter and detector.

19. The headgate of claim 1, wherein the release mechanism comprises a solenoid which causes an engaging pawl of a ratchet holding the weight members in a first position to release the weight members.

20. The headgate of claim 1, further comprising a connection means for connecting the headgate to a piece of livestock equipment selected from the group consisting of a livestock chute, a livestock pen, or a livestock scale.
